(19) United States
(12) Patent Application Publication
(10) Pub. No.: US 2006/0026502 A1
(43) Pub. Date: Feb. 2, 2006

(54) Document collaboration system

(76) Inventor: Koushik Dutta, Irvine, CA (US)

Correspondence Address: SNELL & WILMER LLP, 600 ANTON BOULEVARD, SUITE 1400, COSTA MESA, CA, 92626, US

(21) Appl. No.: 10/900,807

(22) Filed: Jul. 28, 2004

(51) Int. Cl. G06F 17/24

(52) U.S. Cl. 715/511; 715/512

(57) ABSTRACT

The invention relates to a network-distributed document collaboration interface for document review sessions that permits multiple participants to view, markup, and annotate a document simultaneously and in real-time. Both synchronous and asynchronous modes of document collaboration are possible. A network-based application permits the centralized control of documents and collaboration sessions to distributed participants. The document collaboration system also permits saving, retrieving, resuming, and replaying document review sessions and supports concurrent real-time audio, video, and text-based meetings.

### FIELD OF THE INVENTION

Various embodiments of the invention pertain to document collaboration systems. More particularly, at least one embodiment of the invention relates to a document revisions system that permits various people to co-view and co-markup documents in a plurality of file formats, using a web browser, without any originating application installed and can communicate with each other.

### DESCRIPTION OF RELATED ART

Document viewing and marking up software applications typically allow users to view and markup files of various file formats. Some systems even allow users to share desktop applications, thereby enabling the users to have online meetings. The typical document review is the most general concept in organizations that deal with documents. However, traditional document review systems typically require that a collaboration component be installed at all client machines, thereby making deployment more cumbersome. Additionally, these document review system are often limited in the number of file formats supported.

### SUMMARY OF THE INVENTION

One embodiment of the invention relates to a document collaboration and review system that permits multiple users to edit, review, markup, and/or insert comments in a document (e.g., text, graphics, etc.) synchronously and/or asynchronously to facilitate development of documents.

The invention further allows not only viewing and marking up of multiple documents, but also allows sharing of desktops and applications. The system enhances the ability to co-view and co-markup (not desktop/application sharing) that enables the users to view and markup documents exactly at the same time. The integrity of markups (annotations) is retained and multiple users can save their own markups on such documents. This is a document-centric paradigm and not the conventional desktop or application sharing. The markups are associated with the original document and the original authors of these annotations. Hence, the original authors of these markups are the only ones that are allowed to edit and/or delete the markups.

Although having real-time document collaboration is a big asset in an organization, saving valuable time and effort, there is also a need for asynchronous reviewing of documents. This is particularly important when the companies are scattered all around the world in different time zones. One embodiment of the invention provides an asynchronous mode for document collaboration in which various users can create, schedule, and participate in parallel workflows. This means, some users can create workflows, selecting the documents and users present in the system. This information can be in a database management system or it can reside in a file structure.

According to one embodiment of the invention, a calendaring option on a web based interface can be used to define start date to begin and/or due date to finish a document review within an organization. At the time of starting the document review, an email is sent to the defined users. The users then, at their own pace, review the document attached to the document review sessions. All the annotations and markups that the users add on these documents get saved as markup files associated to the original documents. The users do not need to install any viewing application on their client machines. Once, inside the document review session, the users can see the list of documents with sufficient information about the documents and comments made by other users on these documents. The documents can be listed page wise, with or without the list of pages, with markups on them.

The users can browse through the markups/annotations made on the documents. The status of users is also listed within the same interface. The annotations of the users are listed visually on the documents in the form of an icon on the documents. Double clicking these icons display the contents of the comments. Various kinds of editing objects are available. There are comments where various users can add their own comments but cannot edit them. There are note objects, which are only edited by the original authors. The asynchronous mode may be combined with the synchronous mode of document review so that a user can switch between modes as desired.

One embodiment of the invention provides multi-media file capabilities that allows users to open multi-media files without installing any player. In one implementation of the invention, Java Media Framework may be employed for this purpose. Further communication options include audio-video conferencing that allows users to hold audio-video conferences within the same document-centric document review session.

Application and desktop sharing further enhances the information-sharing paradigm and allows user to share desktops and/or applications with the same document collaboration interface.

### BRIEF DESCRIPTION OF THE DRAWINGS

FIG. 1 is a block diagram illustrating a system in which a document collaboration application may be implemented according to one embodiment of the invention.

FIG. 2 is a flow diagram illustrating a method for performing document collaboration review according to one embodiment of the invention.

FIG. 3 is a flow diagram illustrating scheduling and notification of a document review collaboration session according to one embodiment of the invention.

FIG. 4 is a flow diagram illustrating a synchronous document review and/or collaboration session according to one embodiment of the invention.

FIG. 5 is a flow diagram illustrating an asynchronous document review and/or collaboration session according to one embodiment of the invention.

FIG. 6 is a flow diagram illustrating playback or resumption of a document review or collaboration session according to one embodiment of the invention.

FIG. 7 is a flow diagram illustrating how a document review session may be switched from synchronous to asynchronous according to one embodiment of the invention.

FIG. 8 is a flow diagram illustrating how a document review session may be switched from asynchronous to synchronous according to one embodiment of the invention.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

In the following description, certain terminology is used to describe certain features of one or more embodiments of the invention. The terms “user”, “attendee”, “participant”, and “reviewer” are interchangeably used to refer to a person that is involved in a document review and/or collaboration session. The terms “session”, “conference”, and “meeting” are interchangeably used to refer to a defined document collaboration and/or review session where one or more users can synchronous and/or asynchronously participate in reviewing and/or editing a document or file. The terms “document” and “file” are interchangeably used to refer to any electronic text, graphic, data, etc., that may be reviewed, marked-up, and/or edited.

One embodiment of the invention provides a system (e.g., a software system) and interface for collaborative document development that combines viewing, marking up of files in multiple file formats, synchronous, real-time co-viewing and co-markup of documents among multiple participants, and asynchronous or sequential collaboration among a set of reviewers. The system not only allows viewing and marking up of documents in multiple file formats, without an originating application being installed at the user's end, but also, allows real-time and asynchronous collaboration of multiple documents using a web browser. The system is capable of retrieving and saving documents, resuming document review sessions, and/or replaying document review sessions, whether concurrent or sequential.

One embodiment of the invention provides a software system that not only allows viewing and marking up of multiple documents, but also allow users to co-view, co-markup, collaborate and share information across the Internet, intranets and extranets.

Another embodiment of the invention also provides users with a software system that eliminates the need to install any originating software application to view and/or markup files in a plurality of file formats.

Various embodiments of the invention further combine the desktop/application sharing technology in a document-centric collaboration, all within the same interface.

Another embodiment of the invention also provides users the ability to co-view and co-markup multiple documents in a web based interface.

Yet another embodiment of the invention provides a platform-independent document collaboration system that can be deployed on multiple and/or mixed operating system environments (e.g., WINDOWS, UNIX, LINUX, AIX, etc.).

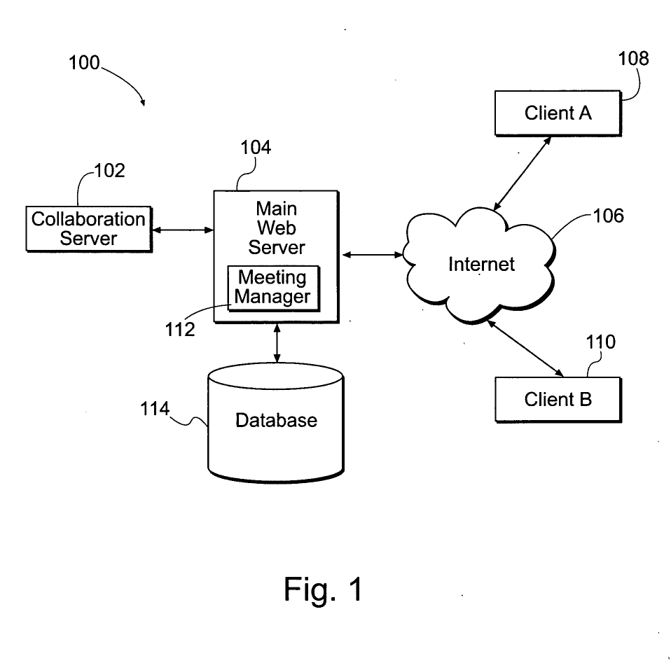

FIG. 1 is a block diagram illustrating a system 100 in which a document collaboration application may be implemented according to one embodiment of the invention. The system 100 includes a collaboration server 102 that acts as the host for setting-up, establishing, and maintaining document collaboration sessions. The collaboration server 102 is communicatively coupled to a main web server 104 that is communicatively coupled to a network 106 (e.g., the Internet) over which it may communicate with one or more client devices 108 and 110. The main web server 104 is configured to host a meeting manager 112 which may be an application that facilitates communications between the collaboration server 102, the clients devices 108 and 110 and a document database 114. The collaboration server 102 receives, processes, and dispatches collaborative events to users or session attendees specified in the event header. The collaboration server 102 keeps track of communication threads for each attendee joining an online or offline collaborative meeting session. Information for a collaborative event or request execution is made available within the application server memory space. The document database 114 is used to store information for permanent usage purposes. Collaboration session information on a volatile memory space of the collaboration server 102 may not be reliable. Information to instantiate a collaboration session is saved in the document database 114. The meeting manager 112 interacts with the collaboration server 102, the document database 114 and the client devices 108 and 110 to retrieve information to list scheduled/finished meetings.

The collaboration server 102, the main web server 104, and the meeting manager 112 operate together to setup document review sessions among participants in a meeting. Synchronous (e.g., real-time) and/or asynchronous document review sessions may be established.

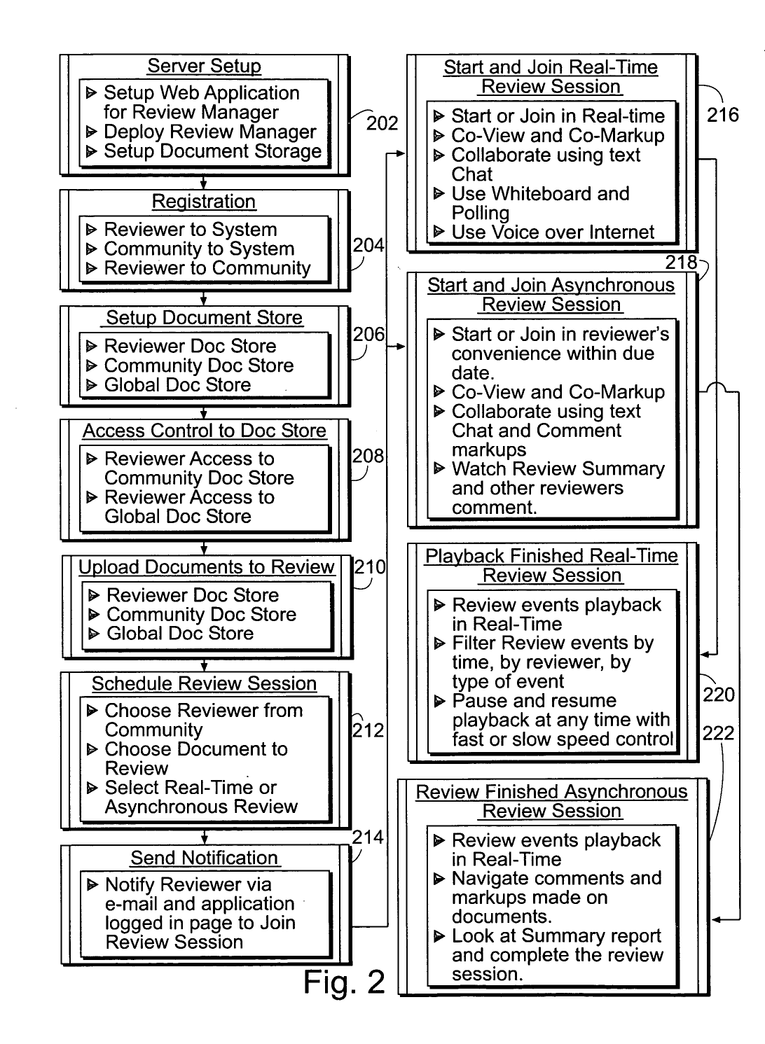

FIG. 2 is a flow diagram illustrating a method for performing document collaboration review according to one embodiment of the invention. A web-based document collaboration review manager (e.g., the collaboration server 102) is setup and deployed (e.g., via the meeting manager 112) on one or more servers and a document storage database (e.g., the document database 114) (setup 202). The users, communities, etc., that are permitted to use and/or access the document collaboration system are registered (registration 204). A document storage structure is setup to store documents for clients, communities, and/or global documents 206 and access control parameters are setup for those documents 208. Information about the stored documents is retrieved by a document collaboration manager 210 (e.g., running in the collaboration server 102). A document collaboration and/or review session may be scheduled by selecting one or more users or reviewers from a community of users, selecting a document to review, and selecting a mode of review operation 212. The one or more users are notified, via email for instance, to join a document review session 214. A review session may then be initiated synchronously (i.e., real-time) and/or asynchronously.

If a user joins a review session synchronously, the user may co-view and/or co-markup a document, collaborate using text chat, use whiteboard and polling features, and use voice over internet to communicate with other users 216. The user may also review events (e.g., markups, comments, etc.) in real-time, filter or search for events by time, user, and/or type of event, and/or pause and resume playback of events 220.

If a user joins the review session in asynchronous mode, the user may co-view and/or co-markup a document, collaborate using text chat and comment, markup, and view summaries of other user's comments 218. The user may also review and/or playback events (e.g., markups, comments, etc.) in real-time, navigate through markups and comments made in the document, look at summary reports made by other users, and complete the review session 222.

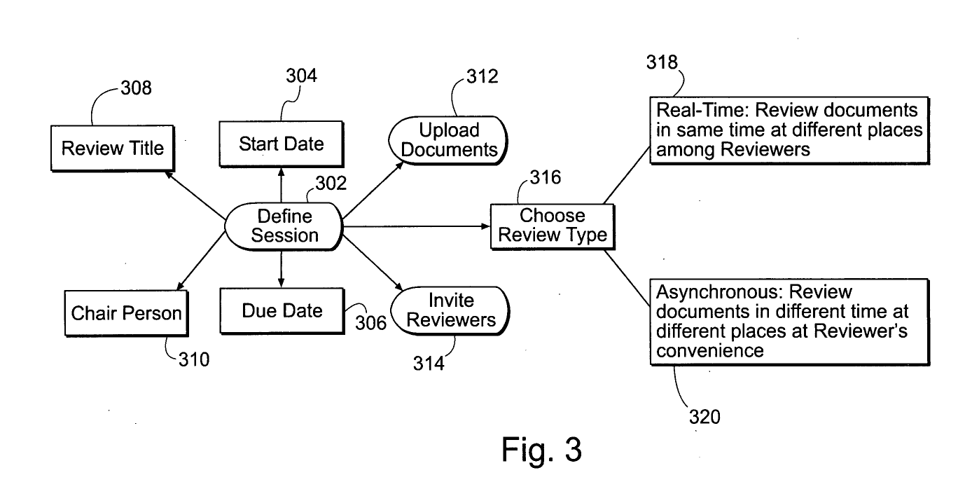

FIG. 3 is a flow diagram illustrating scheduling and notification of a document review collaboration session according to one embodiment of the invention. A document review session involves two major resources—users and documents. Required documents are collected and relocated to a commonly accessible location on the collaboration server 102 for review session users. A session 302 is defined by a start dated 304, a due date 306, a review title 308, and a chair person or responsible user 310. The session documents 312 are then uploaded to the collaboration server 102. Each scheduled session may be allocated with a private directory on the server 104 to upload documents. A shared public meeting directory may also be allocated to store reference documents for all scheduled meeting sessions. The document upload process helps user to upload required documents for collaboration to private or public document folders allocated on the server 104. The selected users are then notified 314 that a session is open and available for review, editing, etc. A mode of document collaboration or review may be defined as part of the session. For example, the document review may be a synchronous (e.g., real-time) 318 and/or asynchronous 320 document review. A synchronous or real-time document review is one where a document may be reviewed and/or edited at the same time by different users. An asynchronous document review is one where a document may be reviewed and/or edited at different times, for instance, at the reviewer's convenience.

According to one embodiment of the invention, prior to starting an online document review and/or collaboration session, the user or reviewer determines if the appropriate collaboration software is already installed on the server and that it can be accessed from a web browser from the client device. The chairperson (the one who starts the online meeting) enters some information like a user name, a unique session identification number, a title of the session or a meeting, etc., and selects a button to start these online meetings or sessions. When integrated with other document/team management systems, this information can be taken from the user information of the existing system.

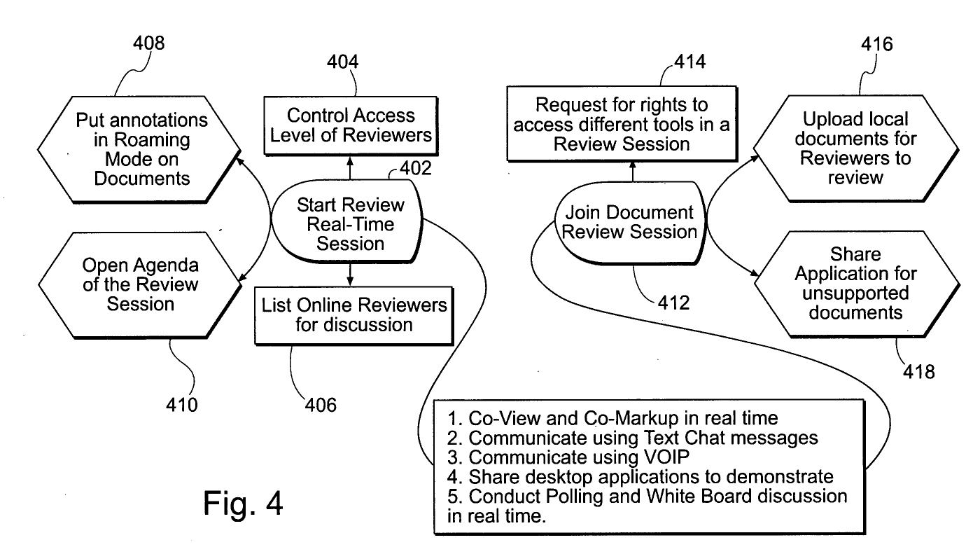

FIG. 4 is a flow diagram illustrating a synchronous document review and/or collaboration session according to one embodiment of the invention. When a synchronous document review session is started 402, access control for users is established 404 and a list of online users is generated 406. According to one embodiment of the invention, reviewers in a collaboration session are allowed with different privileges. For example, depending on their privilege, session users or attendees may:
1. Invite external attendees;
2. Change view operations on documents;
3. View annotations on documents;
4. Create or edit annotations on documents;
5. Participate in text chat conversations;
6. Perform application sharing; and/or
7. Participate in an audio conversation.

Based on the privilege(s) granted to an attendee, these features may be enabled or disabled.

According to one embodiment of the invention, online reviewers may be listed in each active applet sessions or collaboration display window. Reviewer default status, such as Online, Offline, Busy, Idle and Joining, may be indicated for reference. An online user may interact and receive an immediate response. Reviewers can change their status to a customized status strings. A session user or document reviewer in the list can be set to receive whisper messages or directed messages. Messages not selected for whisper or directed, may be broadcasted to all the active attendees joined to the document review session.

Annotations in the documents to be reviewed or edited are set to roaming mode 408 and an agenda is set for the review session 410. Roaming mode allows an attendee to open documents and mark it up within a meeting without allowing anyone else in the meeting to view it. By putting annotations in roaming mode, an attendee may enter comments or redact certain portions of the document before turning the document into collaborative mode. A collaboration session is equipped with roaming mode feature, where attendee opens a version of the document of his own. Once a document is ready to be presented, it can be switched from roaming mode to collaborative mode for all attendees to review and comment.

Each review session may be associated with a predefined agenda for all the reviewers to look at it while they are participating in the collaboration session. By selecting the agenda option, the collaboration session agenda is displayed anonymously for reference by all users.

Once a document review session has been started, other users can join in the session by providing some basic information. When a reviewer seeks to join a document review session 412, access control rights to the document and editing tools are retrieved for the particular reviewer 414. When user information is integrated with existing systems, this information can be taken from an existing user database to join sessions. Access control of each session user or attendee is controlled by the chairperson of the session. Reviewers 406 are equipped with a request tool. Selecting this request tool option sends a request to the chairperson asking for the granting of access controls. Once access control is granted, respective tools are enabled for use. At any time, a chairperson, as the manager of the collaboration session, may withdraw the access controls granted to specific users.

A web interface may also provide the ability for a user to add this information. The ongoing document collaboration sessions can be searched using a session search tool provided in the interface.

Upon request by a user, a requested document is uploaded to the user's system for review and/or editing 416. Where a document format is not supported by a user's system, the document may be displayed and edited via a shared application running on the document collaboration server 418. Providing native viewing support for all varieties of documents available in the industry is a daunting task because of complex reverse engineering methods. At times, viewing a particular document using its native application is a more reliable solution. Collaboration sometimes calls for sharing an application rather than sharing a document. For such needs, the collaboration system offers sharing native applications among a group of attendees in a collaboration session.

In synchronous mode, documents may be viewed and/or marked-up by one or more users at the same time. Users may also communicate using text chat messaging or voice over IP as provided by the collaboration system. A desktop application may also be shared to demonstrate changes, etc. Sharing a desktop or an application permits all the users in a collaboration session to look at the same desktop or application at the same time. The desktop to be shared may appear in a separate window inside the document collaboration system working area. Users may share the applications and/or the entire desktop remotely within a collaborative meeting using the collaboration system. The desktop may appear as a separate window within the document sharing environment. The users can work on the opened documents for co-view and co-markup and at the same time they can share the desktops from a remote location. According to one embodiment of the invention, a single user is allowed to interact with the application at a given time, while others view the application. If remote control permission is granted to other users, they are able to run the application or the desktop, however, the control stays with one person at a time.

The document review and collaboration system also provides polling and whiteboard discussion in real-time to assist editing of the document. The task of polling is to get an opinion poll from the attendees on a specific topic. When the polling feature is selected, the question to be asked is submitted. Different variants of the answers can also be added to the poll. These questions and options may be displayed on the screens of all the session users or attendees. The users or attendees then make their choice and submit the answers. The chairperson of the collaboration session can see the status and the result of the polling at any time by selecting the polling option. The different answer options are shown with the percentage or number of each answer in different colors. This allows the attendees to arrive at a solution where a consensus is required. A whiteboard is a tool that permits session users to put comments on a scratch pad. In a review session before making final annotations, a whiteboard is used to collect general comments on any issues to be discussed. Both textual and graphical annotations may be permitted on a whiteboard screen.

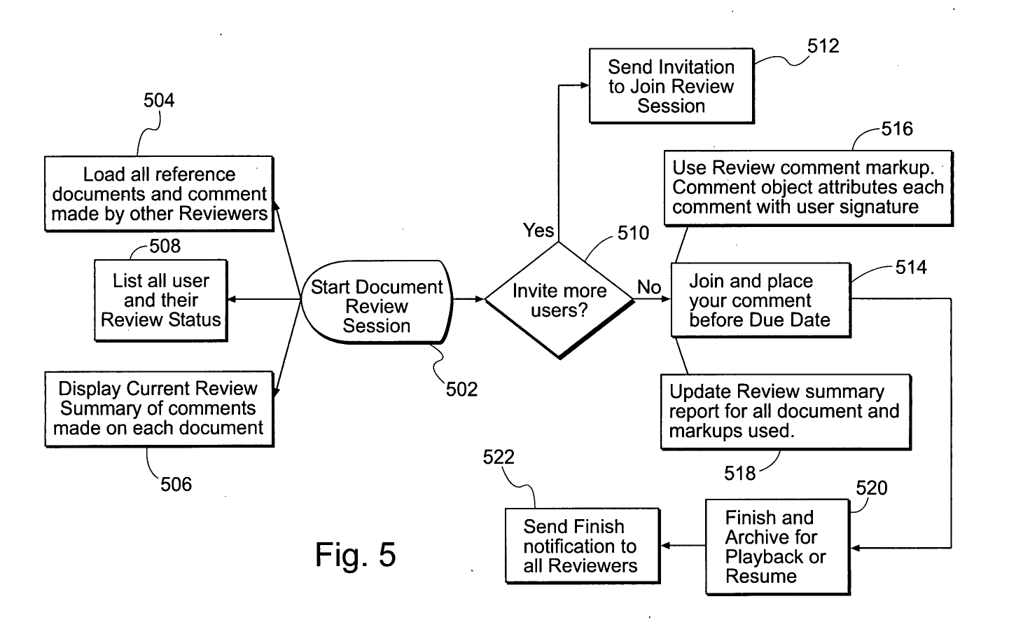

FIG. 5 is a flow diagram illustrating an asynchronous document review and/or collaboration session according to one embodiment of the invention. When an asynchronous document review is started 502, all reference documents and comments made by other participants are loaded onto the reviewer's system 504. A summary of the comments made by other participants may be displayed 506 and a list of all participants and their review status 508 may be provided to the reviewer. If a reviewer elects to invite other participants to edit the document 510, a notification or invitation is sent to the invited participant(s) 512.

A reviewer may also join a document review session and add comments or make changes prior to the due date. The comments made by each participant are tagged with object attributes identifying the participant 516. The comment summary is then updated to reflect any comments entered or changed by the reviewer 518. When a reviewer finishes reviewing and/or editing a document the changes and the document are stored for later playback or resumption of the document review session 520. Other participants are notified that the reviewer has ended his/her document review and changes 522.

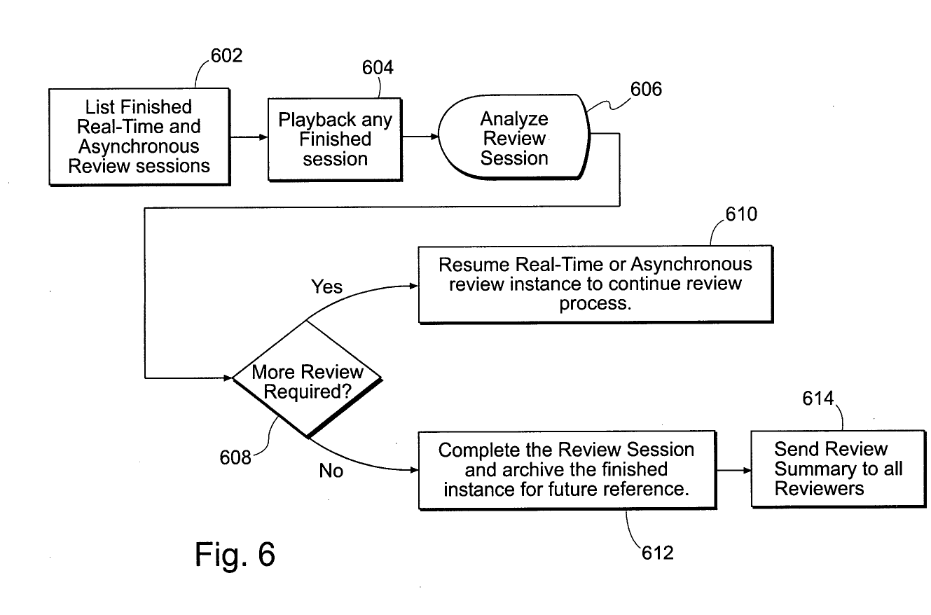

FIG. 6 is a flow diagram illustrating a playback feature of a document collaboration session according to one embodiment of the invention. The system lists finished synchronous and asynchronous document review sessions 602. A user may elect to playback any finished session 604, analyze one or more documents in the session 606, and/or decide if more document reviews or modifications are required or desirable 608. If the user elects to continue the document review session, the session may be resumed in synchronous or asynchronous mode 610. If the user determines that the document review session is finished, the session is archived for future reference 612, and a review summary is sent to all other participants in the session 614.

According to one embodiment of the invention, the creator of an asynchronous document review session can select the document(s) that need to be reviewed using asynchronous mode. The creator can also select the users that are allowed to review these documents. Using a calendar option, the time and date for such reviews can be selected. At the defined due time and date, these documents are finished, unless the creator forces them to close earlier. When a document review session is started or setup, a notification, such as an email, is automatically sent to the invited participants. The participants, at their own pace, may select the links provided to review the documents associated with a session. These documents can be of any supported file format.

In one embodiment of the invention, the documents associated with a review session may be displayed using a web-based interface. There is no need to install any separate viewing application to view and annotate these documents. Various viewing operations can be performed within the same interface. For example, a general discussion area may be provided where participants can add their comments that are posted to all other users when they log into the system. The participants can also add their individual comments on the documents that get saved as a markup file. The option of browsing the markups is also provided. Users can list the pages with markups within the available documents. Markups or annotations are layers on top of the document being displayed. This layered markup can be selected and moved around the document frame. Each markup can be deleted or modified by the owner. Created markups can be saved, unloaded and/or loaded. Markups being saved to a file may be associated with defined relationships. The rules used to define these relationships may be used to locate the markup file for retrieval.

According to one embodiment of the invention, the entire online document review session or meeting can be saved as extended markup language (XML) files on the server or any location in the network. When ending a meeting, the chairperson may be asked to save the meeting for later playback or review. If the chairperson decides to save the meeting, a file name is provided by the chairperson. The meeting events may be saved within a lightweight XML file. In this manner, previously held document review sessions can be played-back at any time, by selecting a corresponding link provided in a session history interface. The entire session, with events, is then played back. The options for automatic and manual (step-by-step) playback are provided. Real life meetings are recorded using video devices and played back repeatedly in future occasions. Collaboration sessions include a set of events generated by reviewers. The meeting events records can be saved as elements/nodes within an XML document. The collaboration server 102 may access all the events recorded in a specified XML document and post them to a client applet session when a meeting playback is requested. Major events, such as attendees joining meeting session, open document events, change view operations, textual chat, and graphical annotations made on documents, may be displayed to the participants of playback session.

Various document review modes may be available to a document review participant. According to one embodiment of the invention, the review modes include: view only (VO) mode, view and markup (VM) mode, view, markup and collaboration (VC) mode. These modes can be switched on or off according to the usage of the document review and collaboration system. For example, if the reviewer or user requires viewing of the files present on a centralized location in the network or from their local drives, VO mode can be started. If there is a requirement for adding markups on the document, the VM mode can be started. If the users want to collaborate on one or more session documents, the VC mode can be started. If the user requires real-time document collaboration, the real-time session can be started where various participants can join and review the document(s) together in real-time. If there is a need for asynchronous reviewing of one or more session documents, the asynchronous mode can be started. All these features can be packaged at one place or can be taken out, depending on the needs of the users.

The files or documents present in the document database or repository can be opened within an online document review and/or collaboration session. These files can also be pre-opened when a user or reviewer joins the meeting. The document review and/or collaboration system may provide an interface having a tree-like structure of the files present for review so that users can browser through them. Multiple files can also be opened and other features include virtual pages, open in roaming mode, files type associations, etc. Sets of individual, single page documents are logically assembled to form a multiple page document. Individual document sequence numbers are specified next to the base document name that helps to map logical page numbers to actual document name available in the current directory from which the document is selected. Logical pages may be termed as “Virtual Pages” within a collaboration viewing session.

In a collaboration session, every document may be opened in a collaborative mode, where every user can see the same document while joined an online collaboration session. Some attendees may open documents for their personal viewing only and do some annotations before sharing the document with other users. Opening documents in this mode is called “Roaming Mode.”

Once the files are opened within the document review and collaboration application, various annotations can be added on these documents. Markup tools in the user interface allow participants to add different types of markups.

The annotations can be saved on the collaboration server or on the local drives of the users or reviewers. A user may be asked to provide a file name for the markups and annotations to be saved. These markup files are associated with the original file. The markup file names can also be automated to add a date and time stamp with the markup file's name. This kind of integration is helpful in avoiding users having to give their own file names for the markups. The system adds a markup file name while in this mode.

All the previously saved markup files can be loaded onto the original document by opening the original document and selecting the desired markup file. While listing the markup files that are associated with the original document, only the ones that are related to the original document are displayed. Markup files of other documents are not listed. This enables a fast browsing through the markup files present in the system. The interface can also have options to display the size and date of creation of these markup files.

In one embodiment of the invention, users can start only a view and/or view/markup session. This means the users can use the system as a server-side viewer and markup tool. According to one embodiment of the invention, documents viewed from a server within a document collaboration system may display a markup tool. Otherwise only a viewing tool is displayed by default. In these operating modes, the collaboration features, such as chat communications, are not displayed.

It may also be desirable for a user to switch between synchronous and asynchronous document review modes. While being in one mode of operation (e.g., synchronous or asynchronous), a user can change the document review mode by selecting from a drop down list of modes. This allows users to quickly change the mode and even switching between these modes at any time. This means, the system can become a stand-alone viewer at any time, while still being a collaborative session.

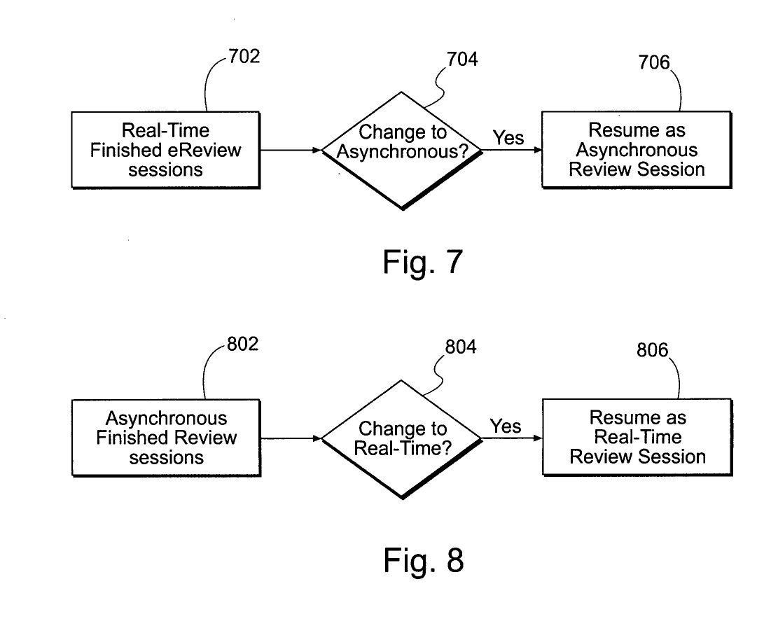

FIG. 7 is a flow diagram illustrating how a document review session may be switched from synchronous to asynchronous according to one embodiment of the invention. When a synchronous or real-time document review session has finished 702, at the reviewer's option, the review mode may be changed to asynchronous 704. The reviewer may then elect to resume the document review session asynchronously 706.

FIG. 8 is a flow diagram illustrating how a document review session may be switched from asynchronous to synchronous according to one embodiment of the invention. When the asynchronous review session is finished 802, at the reviewer's option, the review mode may be changed to synchronous 804. The reviewer may then elect to resume the document review session synchronously 806.

The users present in an online document collaboration session can view the documents simultaneously. If a user changes the view of the document, operations such as zooming-in and/or zooming-out are exactly reflected on everyone's screen. This is different from screen-sharing because the users do not merely share their screen, but they also share the documents. Multiple documents can be opened and viewed within the same interface. The viewing interface takes care of the entire native viewing of these documents, without any need for any other external viewing software. The users can also, alternatively, share their desktops and/or applications within the same environment. Application sharing and Desktop sharing are two possible options available while using remote sharing tool in document collaboration session. Sharing a desktop permits the users or session attendees to see whole applications actively running on a desktop system. If a user is only interested in sharing a specific application and keep other applications protected from remote sharing protocol, then the application-sharing option is selected.

One embodiment of the invention also provides a roaming mode wherein the collaborative viewing mode, viewing and marking up can be changed independently on certain documents. This enables users to work independently on certain documents, referred to as roaming mode, at the same time, while collaborating on others. This gives freedom to work on documents while still in a collaborative session on documents. This is entirely a document-centric paradigm.

In another embodiment of the invention, users can hide or redact certain areas or portions of document(s) being reviewed. This helps hide sensitive information from other users. If the users want to hide certain areas of a document, they can redact them and the other users do not see the hidden part. Another use of this redaction can be opening the documents in a roaming mode and hiding certain areas and then changing the mode to collaborative, so that the other users just see the information meant to be displayed.

Another feature of the invention provides for an interface that allows users to open the documents or files from both a centralized location and the local drives. The chairperson may set permissions to permit users, reviewers, or attendees to do this.

The users are also given a choice to save copies of documents locally or on the network database or server. This means, for example, that professional engineering file formats can be saved as raster formats with or without markups locally. When saving documents in raster format with markups, the markup layer is combined with the document to create a raster image that includes both the document and markups. This feature permits users to save both the markup layer and document as a snapshot, instead of saving markups and documents separately. This is done by a conversion mechanism in the document collaboration system.

The users may also be given a choice to upload the files to the collaboration server. An upload utility may be provided that can handle uploading multiple files of any size.

Another embodiment of the invention permits for the session chairperson to conduct polling inside a meeting or session to receive feedback from other participants. This polling feature allows the chairperson to enter a question with multiple choice answers. These multiple choice answers may include any number of variants. After submitting the poll question, the participants get an instant dialog box with the question and answers. A participant has to select an answer and submit it. The chairperson gets immediate notification as to how many participants have answered. The chairperson also gets a graphical view of the polling with the percentage of the attendees and the answers. The chairperson can also close the polling and the results of polling may be published in the general discussion area on the screens of all participants.

Users can add various types of markups in an opened document. These markups can be graphical in nature as well as text-based. While adding text, the user may select the appropriate editing option and location on the document to be marked. Graphical objects may be added to the document or file by a click-and-drag method. Text markups can also be added to the desired location using text-editing tools that appear on the top portion of the user interface.

Instead of using markups, users may also add note objects to desired portions in a document. Selecting the notes button and then clicking on the document allows the user to create and insert a note object into the document. The note object is shown in the selected portion of the document and can be used to store a large amount of text. This may be done to avoid clogging up the body of the document with large text markups.

One embodiment of the invention permits users to add or embed other documents with documents as markup objects. These embeded documents get saved as markup objects and are saved within the marked-up file. These objects may be treated as markup objects and only the original authors of these markups are allowed to edit them.

Another embodiment of the invention also allows reviewers or users to add threaded discussions on certain portions of a document. This allows users to have a trail of discussions related to the document. These threaded discussions are different from the general chat area provided. The threaded discussions can be re-activated at any time, by the original author and appended to existing discussions.

According to one embodiment of the invention, users can have a text-based, real-time chat within the same document sharing environment. These chat messages are transmitted in real-time to all participants or among selected participants. Various options, such as direct, whisper mode, etc., are available. While in “whisper” mode, only the desired participants can see the text chat. This is meant to provide secured communications or discussions while still in a meeting with other users.

Another embodiment of the invention permits participants to have audio-based communications while within the document sharing environment. This feature may be based on a Java Runtime environment and does not need any other plug-in to be installed in the web-based document browser.

One embodiment of the invention permits attendees to have an audio/video (A/V) conference within the document collaboration session. This may be accomplished, for example, where attendees have Java Media Framework installed on their local machines and an audio-video server component installed on the server. A user may start an A/V conference by selecting this option from the user interface. If the user has an A/V capturing device, such as a cameras and/or microphone, the other participating users can see and hear each other.

One embodiment of the invention provides a centralized document collaboration system having a document collaboration server configured to host a document collaboration session. One or more documents associated with the document collaboration session and one or more lists of authorized participants who are permitted to join the document collaboration session is maintained by the system. When a document collaboration session is established a notification is sent to the authorized participants.

The web-based document-centric collaboration system allows saving of markups as well as retrieval of markups in synchronous and asynchronous document sharing sessions. The document collaboration system permits viewing and marking-up and saving of markups in separate markup files. These files get associated with the original documents and markups within these markup files are based on the author who made these markups. Only the original authors are allowed to edit their markups.

Markup files are saved and reside in a location on a server or anywhere on the network. Markups retain and are associated with the author of the markups. The markups made by various authors cannot be edited or altered by other users of the system. Unlike screen sharing where the markups are made by only the user whose screen is being shared, the document collaboration system associates markups with the author's information and the original author is the owner of the markups.

One or more network-distributed client interfaces (e.g., web browser application on networked computers) are communicatively coupled to the document collaboration server. At least one client interface is configured to permit an authorized participant to access the document collaboration session, review the one or more documents associated with the document collaboration session, make simultaneous changes to the one or more documents, and propagate the changes made to the one or more documents by the one or more participants to all other participants.

According to one embodiment of the invention, such client interface for collaborating on documents may be distributed over a network (e.g., the internet, extranets and/or intranets), using a web-based browser connected to a web server. The document collaboration system combines viewing, marking-up, real-time collaboration, asynchronous collaboration, and sharing of information and communication, all at once. In one embodiment of the invention, a centralized web server manages communications between the document collaboration system and the distributed clients. The web browsing interface may access the web server using Hyper Text Transfer Protocol (HTTP) and/or Hyper Text Transfer Protocol Secured (HTTPS).

One embodiment of the invention provides a web-based document-centric collaboration system, wherein the session documents can be viewed and marked up without using the originating application, within a web browser.

One embodiment of the invention provides a document-centric collaboration environment in which a document collaboration session may be viewed from a centralized location in a computer network. This allows for quick and easy navigation and interaction of changes in documents with co-reviewers, saving and retrieval of markups (annotations) on these documents, and commutations (e.g., text-based, telephony, and/or audio-video) within the same document-sharing interface (e.g., web browser) without any additional software system.

The web based collaboration system combines the generic view and markup systems along with the meeting capabilities. These web-based meetings can be accessible through web browsers. The online meetings can be started, joined, saved, and played back using a web browser that has necessary plug-ins already installed.

According to one embodiment of the invention, the document collaboration user interface is Java based to provide platform independence.

The web-based system also allows participants to start a parallel workflow to review the session documents. These documents can be viewed using the web browser and the document information can be routed among various participants of the workflows. The users can add other users within the scope of the workflows that can retrieve markups and can also add their own markups.

The web-based collaboration system that gives meetings a differentiating meeting ID which is associated with the particular meeting. This helps users to join the ongoing meetings and is also used while saving and replaying meetings at a later time.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A method for document collaboration, comprising:
establishing a document collaboration session;
defining a group of one or more users permitted to participate in the document collaboration session;
defining one or more documents to be part of the document collaboration session;
defining a synchronous mode or an asynchronous mode of operation for the document collaboration session;
permitting the one or more users to make changes to the one or more documents; and
propagating the changes to the one or more documents to the users in the group.

2. The method of claim 1 further comprising:
establishing a start date and time for the document collaboration session;
establishing a due date and time for the document collaboration session; and
notifying the group of one or more users that the document collaboration session has been established.

3. The method of claim 1 further comprising:
annotating the one or more documents as indicated by one of the users; and
inserting notes into the one or more documents.

4. The method of claim 1 further comprising:
maintaining a record of the changes made to the one or more documents; and
playing back the record of changes made to the one or more documents.

5. The method of claim 1 further comprising:
establishing audio/visual communications between two or more users.

6. The method of claim 1 further comprising:
establishing text chat communications between two or more users.

7. The method of claim 1 further comprising:
changing the mode of operation between synchronous mode and asynchronous mode.

8. The method of claim 1 further comprising:
making simultaneous changes to the one or more documents by one or more users.

9. A machine-readable medium having one or more instructions to provide a document collaboration interface, which when executed by a processor, causes the processor to perform operations comprising:
establish a document collaboration session;
define a group of one or more users permitted to participate in the document collaboration session;
define one or more documents to be part of the document collaboration session;
define a synchronous mode or an asynchronous mode of operation for the document collaboration session;
permit the one or more users to make changes to the one or more documents; and
propagate the changes to the one or more documents to the users in the group.

10. The machine-readable medium instructions of claim 9 further comprising:
establish a start date and time for the document collaboration session;
establish a due date and time for the document collaboration session; and
notify the group of one or more users that the document collaboration session has been established.

11. The machine-readable medium instructions of claim 9 further comprising:
annotate the one or more documents as indicated by one of the users; and
insert notes into the one or more documents.

12. The machine-readable medium instructions of claim 9 further comprising:
maintain a record of the changes made to the one or more documents; and
play back the record of changes made to the one or more documents.

13. The machine-readable medium instructions of claim 9 further comprising:
make simultaneous changes to the one or more documents by one or more users.

14. The machine-readable medium instructions of claim 9 further comprising:
establish audio/visual communications between two or more users.

15. The machine-readable medium instructions of claim 9 wherein the document collaboration interface is provided over a network-based application and the one or more documents are viewed from a centralized location.

16. A system comprising:
a document collaboration server configured to
host a document collaboration session,
store one or more documents associated with the document collaboration session,
maintain a list of authorized participants who are permitted to join the document collaboration session,
notify the authorized participants that a document collaboration session has been created; and
one or more network-distributed client interfaces communicatively coupled to the document collaboration server, at least one client interface configured to
permit the authorized participants to access the document collaboration session,
permit the authorized participants to review the one or more documents associated with the document collaboration session,
permit the authorized participants to make simultaneous changes to the one or more documents, and
propagate the changes made to the one or more documents by one of the participants to all of the authorized participants.

17. The system of claim 16 wherein the one or more network-distributed client interfaces are further configured to permit the one or more participants to
annotate the one or more documents,
insert notes into the one or more documents,
save a record of the changes made to the one or more documents; and
play back the record of changes made to the one or more documents.

18. The system of claim 16 wherein the one or more network-distributed client interfaces are further configured to
establish audio communications between two or more participants.

19. The system of claim 16 wherein the one or more network-distributed client interfaces are further configured to
establish text-based chat communications between two or more participants.

20. The system of claim 16 wherein the document collaboration server is further configured to
permit either synchronous or asynchronous document collaboration from the one or more participants from a centralized web server communicatively coupled to the document collaboration server.

21. The system of claim 16 wherein the changes made by a first participant is associated with that first participant.

22. The system of claim 22 wherein the changes made by the first participant cannot be edited by any other participant.

23. The system of claim 16 wherein the network-distributed client interfaces are configured to permit participants view the markups according to the names of the authors.
